(19) United States
(12) Patent Application Publication
(10) Pub. No.: US 2007/0056453 A1
(43) Pub. Date: Mar. 15, 2007

(54) Sheet stacking device

(75) Inventor: Johannes H.A. Dinnissen, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/511,483

(22) Filed: Aug. 29, 2006

(30) Foreign Application Priority Data
Aug. 31, 2005 (NL) 1029837
Feb. 23, 2006 (NL) 2000015

(51) Int. Cl. B41F 13/24

(52) U.S. Cl. 101/232

(57) ABSTRACT

A stacking device for incoming sheets, including a receiving plane, a rotatably arranged element, containing a slot at its circumferential edge for accepting at least a portion of a sheet to be stacked, where, in a first rotation zone, the rotatably arranged element accepts the sheet to be stacked and, in a second rotation zone, the accepted sheet is conveyed onto the receiving plane, drive mechanisms for driving the rotatably arranged element, a stop, a closed-loop shaped friction element mounted at the circumferential edge of the rotatably arranged element, which, in operation, transfers a force onto the upper side of the sheet emerging from the slot during at least a part of one revolution of the rotatably arranged element, this force having a component directed towards the stop, wherein the closed-loop shaped friction element is positioned such that, in operation, it does not obstruct the movement of a sheet while the latter is accepted into the slot in the first rotation zone.

This application claims the priority benefit of Dutch Patent Application No. 1029837 filed Aug. 31, 2005 and Dutch Patent Application No. 2000015 filed on Feb. 23, 2006, which are hereby incorporated by reference.

### BACKGROUND OF THE INVENTION

The present invention relates to a stacking device for incoming sheets, comprising a receiving plane or station, a rotatably arranged element, containing a slot at its circumferential edge for accepting at least a portion of a sheet to be stacked, where, in a first rotation zone, the rotatably arranged element may accept the sheet to be stacked and, in a second rotation zone, the accepted sheet is conveyed onto the receiving station, drive mechanisms for driving the rotatably arranged element, a stop, a friction element e.g., a closed-loop shaped friction element mounted at the circumferential edge of the rotatably arranged element, which, in operation, during at least part of one revolution of the rotatably arranged element, transfers a force onto the upper side of the sheet emerging from the slot, this force having a component directed towards the stop. The present invention also relates to a sheet edge retention hook.

A device of this kind is known from U.S. Pat. No. 5,065,997 and an embodiment thereof, which also comprises a friction element is commercially available in the High Capacity Stacker (HCS) from CP Bourg. This known device includes a pair of disks which have been mounted onto a driven rotation shaft. Each one of these disks comprises a pair of acceptance slots, as well as a pair of friction elements. During the course of a cycle, incoming sheets may be accepted into the slots that have been made in the disk. If applicable, the incoming sheets have already sustained an initial lateral registration course and are conveyed into a slot by means of an input clamping arrangement. An accepted sheet is conveyed onto a receiving plane during part of the revolution, after which the friction elements will convey the sheet against a stop during part of the revolution.

A disadvantage of this known device is that, in use, it is not sufficiently precise in producing accurately formed stacks. In use, it regularly happens that sheets stacked by the known device fail to end up in an orderly manner on the stack formed on the receiving plane. Deviations in the orientation of sheets relative to one another and relative to the reference planes are highly undesirable, particularly if the stacks are to be further post-processed, such as in binding applications.

### SUMMARY OF THE INVENTION

An object of the present invention is to provide a stacking device for incoming sheets, where the sheets are accurately stacked in a reliable manner. To this end, a device has been developed wherein a closed-loop shaped friction element has been positioned such that, in operation, it does not obstruct the movement of a sheet while the latter is accepted into the slot in the first rotation zone. In the device according to the present invention, the registration of incoming sheets already performed is retained more effectively and there is no additional obstruction to the incoming movement of sheets. Due to the positioning of the friction elements, according to the present invention, a significant improvement is achieved of the alignment of the stacks formed on the receiving plane. Any further binding processes may therefore form more accurate documents and the user will experience, also in cases where no further post-processing is performed, a higher quality of stacks and delivered documents.

Due to the choice of the position and the material of the closed-loop shaped friction elements according to the present invention, sheets conveyed from the slot onto the receiving plane, or onto an already formed stack are conveyed against the stop in a controlled manner. It will be understood by those skilled in the art that the geometry and the material of the closed-loop shaped friction elements used must be chosen such that, during this registration action, sheets do not suffer damage at the sheet edge which comes into contact with the stop, and that the closed-loop shaped friction element does not damage or deform the upper side of the delivered sheet, while sufficient force may still be transferred to convey the sheets against the stop.

The device according to the present invention may be used in any application where incoming sheets are to be stacked. The device according to the present invention may be conveniently used, particularly in a stacking device which may be mounted behind a printer, to feed printed sheets onto a straight stack.

In one embodiment according to the present invention, the closed-loop shaped friction element is mounted at a position along the circumferential edge of the rotatably arranged element, wherein this position, as seen in the conveying direction of the rotatably arranged element, is more than one-half of a circle arc removed from the beginning of the slot.

This embodiment is convenient, as this position will not obstruct an incoming sheet, so that the sheet may be left better aligned on the receiving plane. If, for example, an assembly of two rotatably arranged elements is used, where the closed-loop shaped friction elements were produced from the exact same material, the sheet would still be affected by contact during insertion into the slot. This effect is even likely to increase, the longer the device remains in use.

If the closed-loop shaped friction element is positioned at more than one-half of a circle arc removed from the beginning of the slot with which the closed-loop shaped friction element works in unison, i.e., the friction element that will cause friction to the sheet coming from the relevant slot, a sheet will not be affected by that element when it is inserted into the slot, whereas the operation of the element will remain intact.

In one embodiment, the drive mechanisms mounted for driving the rotatably arranged element, is driven in such a way that the moment of steering in a sheet to be stacked and the position of the rotatably arranged element are synchronised. This is convenient as it considerably improves the reliability of the device. This is due to the fact that a sheet that is being steered in should be conveyed from the input clamping arrangement into the slot in an as reliable a manner as possible, preferably without negating the registration course that may already have been performed.

In one embodiment, the rotation speed of the rotatably arranged element, in operation, maintains a speed profile that is not constant. This is convenient, as it allows higher productivity where possible, while sufficient accuracy is maintained at points during the process where this is necessary or desirable. Thus, in a further embodiment, the rotatably arranged element, in operation, may be halted in the first rotation zone. This is convenient, as a sheet may be conveyed more simply and more accurately into the slot from the input clamping arrangement. This means that the control and construction of the input clamping arrangement may be embodied in a less complex arrangement, if desirable.

In one embodiment, the rotation speed of the rotatably arranged element in operation is increased between the second rotation zone and the return to the first rotation zone. This is convenient, as it reduces the total time taken for the rotatably arranged element to complete one revolution, while during the period that follows the second rotation zone, i.e., after an accepted sheet has been conveyed onto the receiving plane and before the return to the zone in which a new sheet may be accepted, no sheet will be present in the slot and therefore no extremely strict requirements will be imposed on the maximum rotation speed of the rotatably arranged element. A reduction in revolution time will lead to a higher potential productivity.

In one embodiment, the device comprises a sensor to indicate when the first rotation zone of the rotatably arranged element has been reached. This is convenient, as it enables more effective synchronisation between the receiving position of the slot and the driving of the input clamping arrangement. A sensor increases the reliability in respect of, for example, blindly retaining the position of the rotatably arranged element, as a deviation in the receiving position of the slot which may lead to a sheet being accepted less accurately into the slot. A sensor of this kind may, for example, comprise an optical sensor which has been mounted in such a way that it may detect one or more positions in the rotatably arranged element, which are, for example, marked by one or more slots. A sensor of this kind may also comprise a magnetic sensor, where the position markings have been produced by a material detectable by a sensor of this kind. Other detection methods may also be used. If a non-constant rotation speed profile is chosen, as described above, one or more of the phases of the rotation speed profile may be signalled by means of a sensor of this kind. If, for example, the speed is increased between the second rotation zone where a sheet is conveyed onto the receiving plane and the return to the first rotation zone, for example to achieve increased productivity, the speed may be reduced in the first rotation zone just before the receiving position is reached, so that the receiving position may be estimated more accurately. By reducing the speed just before the rotatably arranged element regains its receiving position, the rotatably arranged element may be slowed down more effectively the moment the sensor detects that the receiving position has been reached.

In one embodiment, the closed-loop shaped friction element comprises a material at its circumferential edge that has a high friction ratio relative to the sheet. This is convenient, as it leads to more effective friction between the friction element and the sheet, so that in operation, the sheet is conveyed more effectively against the stop.

It will be understood that the friction between the closed-loop shaped friction element and the sheet should not be chosen too high as this may, in some cases, produce deformation to the sheet, image or sheet edge. Also, the material of the closed-loop shaped friction element must of course be chosen such that it does not produce lines or other artefacts when the sheet is brushed against the stop. The closed-loop shaped friction element does not need to consist entirely of one material only but may also be an embodiment comprising various materials, possibly arranged in a layered configuration. Thus, the flexibility and spring force of the element may be dominated by an initial layer, while the friction characteristics are predominantly determined by the layer where the sheet and friction element touch.

In one embodiment, the rotatably arranged element comprises a freely rotatable guide wheel at the entry point to the slot, positioned and dimensioned such that it extends beyond the circumferential edge of the rotatably arranged element, though it remains within the outer demarcation of the slot. A wheel of this kind will allow an incoming sheet with a lower slide resistance to be accepted into the slot and will improve directional guidance, thus reducing smearing of any printing pattern produced. The improved directional guidance produced by a freely rotatable guide wheel will decrease the risk of a sheet being accepted into the slot in a misaligned manner.

The present invention also relates to a sheet edge retention hook, where an initial side comprises attachment mechanisms such that the hook may be attached to a frame at least over a part of one revolution while rotating freely and a second side is shaped such that in essence, a horizontally disposed incoming sheet may be easily accepted under the retention hook. This is convenient, as it reduces curling at the edge of the accepted sheet, so that any subsequent sheet may be accepted on top of it in a more reliable manner. The sheet edge retention hook also restricts any horizontal displacement of an accepted sheet, as the retention hook may raise a counter force. Furthermore, the hook also has a braking effect on the incoming sheet, thus significantly reducing noise. The force, with which the retention hook presses an accepted sheet against a surface may, for example, be produced by the retention hook's own weight in a gravity field, by means of a torsion spring at the position of the attachment to a frame or in another manner, for example by means of magnetic pull.

A sheet edge retention hook of this kind may be conveniently applied into a stacking device for incoming sheets as described above. This is because sheets will, in essence, enter horizontally onto a receiving plane and it is convenient for the horizontal movement of a sheet to be fully restricted for the movement of the sheet edge in a direction perpendicular to the receiving plane to be counteracted in order to be able to form an accurate stack in a highly reliable manner.

### BRIEF DESCRIPTION OF THE DRAWINGS

The present invention will now be further explained with reference to the following drawings, wherein

FIG. 1 shows a stacking apparatus in which a device according to the present invention has been mounted;

FIG. 2 shows an embodiment according to the present invention;

FIG. 3 shows a side view of an embodiment according to the present invention;

FIGS. 4A-4F shows the operation of the device according to the present invention;

FIG. 5 is an example showing a possible rotation speed profile;

FIG. 6 is an example of the present embodiment with a smearing wheel;

FIG. 7 is a top view of the registration ruler;

FIGS. 8A-8B are diagrams showing perspective representations of a transport wheel in a registration ruler; and

FIG. 9 is an axle with a bearing that provides play in the transport direction.

### DETAILED DESCRIPTION OF THE INVENTION

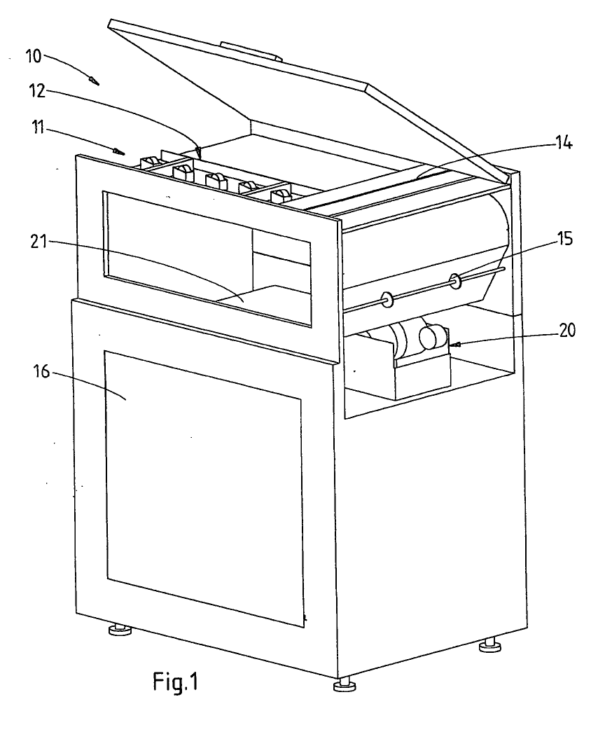

FIG. 1 is a diagram showing a stacking apparatus 10 in which a device according to the present invention has been mounted. A stacking apparatus 10 of this kind may, for example, be mounted behind a printer. By coupling a printer's sheet outlet to the entry point of the stacking device, sheets from the printer may stacked neatly when the registration actions are performed by the stacking apparatus. A stacking apparatus 10 of this kind may be embodied with various output facilities, such as, but not limited to, a pallet output facility for easily feeding stacks from the stacking device onto a pallet, and a binding facility for binding the stacks together, for example using a plastic strip or another method, in order to maintain the shape of the stack during transport.

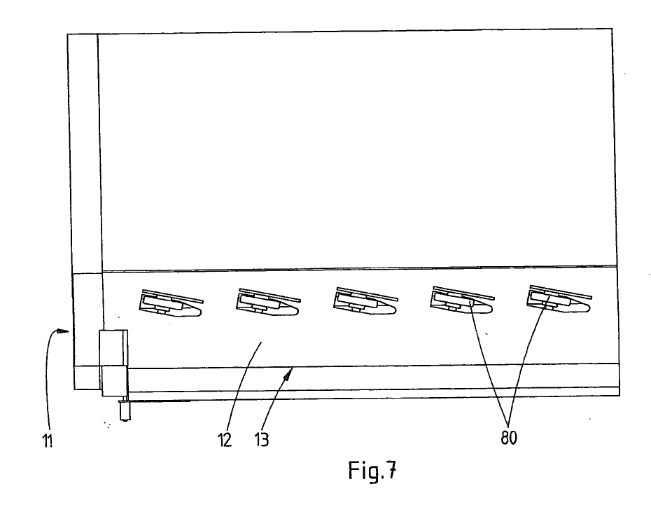

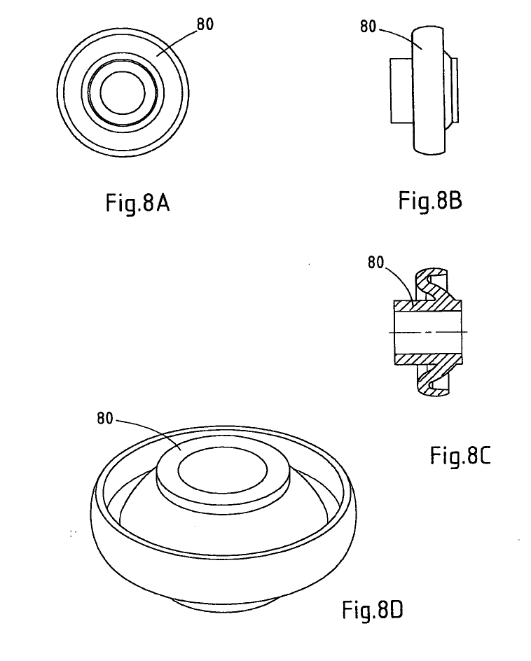

The stacking unit 10, as shown in FIG. 1, receives sheets via sheet inlet 11. A sheet which has been fed in is then conveyed against a registration wall 13 by means of a registration ruler 12. A top view of this registration ruler 12 is shown in FIG. 7. In the embodiment shown, the transport clamping arrangements of registration ruler 12 have been formed in such a way that a force is transferred from the clamping arrangement onto the sheet in the direction of registration wall 13. As soon as the sheet lies against the registration wall, the force of the clamping arrangement on the sheet will predominantly be applied in the direction of transportation and, to a lesser extent, in the direction of the registration wall 13, as sheet deformation may occur if excessive force is applied when a sheet is conveyed against a registration wall. This may be achieved by providing the transport clamping arrangement of the registration ruler with wheels that are more flexible in the one lateral direction than in the other lateral direction. This effect is achieved by modelling transport wheels 80 as shown in FIGS. 8A-8D. The moment a sheet lies against the registration wall, the transport wheel will bend outwards and transfer a force that is predominantly directed in the transport direction, causing a sheet that has reached the registration wall to be pushed against the wall without excessive force, thus preventing sheet deformations.

Because of this first registration action, all sheets enter reversing loop 14 at the same height. Behind this reversing loop 14, an input clamping arrangement 15 is positioned, which forms the inlet transport into the module, inside which a device according to the present invention is mounted. This module feeds incoming sheets into a straight stack onto a receiving plane 21. This receiving plane 21 may be height adjustable, so that the stacking capacity of the stacking unit may be increased. The stack may be removed from the unit via an opening hatch or another type of outlet opening 16. Stacking unit 10 may also comprise means (not shown) to assist a user in removing the stack from the unit, for example by conveying the stack out of the stacking unit, in whole or in part. This may, for example, be embodied as a power-steered drawer, which, after opening outlet opening 16, is conveyed out of the unit. A stacking device of this kind may be either electronically connected to a printer so that the timing of sheets may be communicated, or embodied fully autonomously, where the timing of incoming sheets is detected by the stacking unit itself.

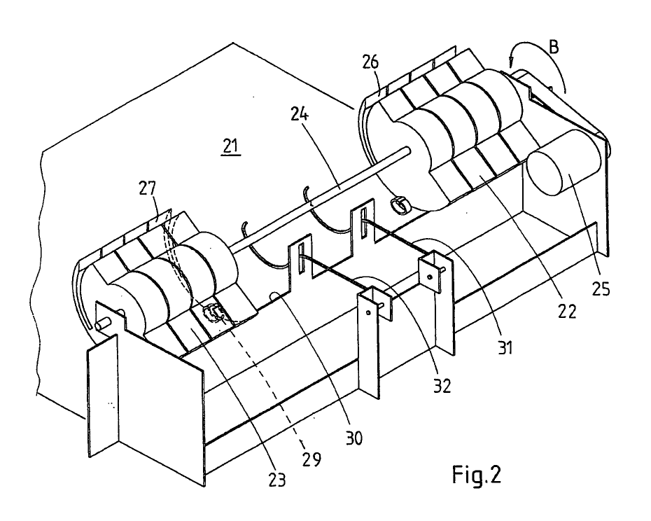

FIG. 2 is a diagram showing a device according to the present invention. It comprises a receiving plane 21 and two rotatably arranged elements 22 and 23, which are connected to an electrically driven motor 25 and rotation shaft 24. A device may comprise one or more rotatably arranged elements of this kind. Electrically driven motor 25 may, for example, be an electric servo motor or stepping motor. The rotatably arranged elements comprise slots 26 and 27 in which an incoming sheet may be accepted in whole or in part from input clamping arrangement 15. In the position shown in FIG. 2, rotatable elements 22 and 23 are located in the first rotation zone, in which the leading edge of a sheet may be accepted into slots 26 and 27.

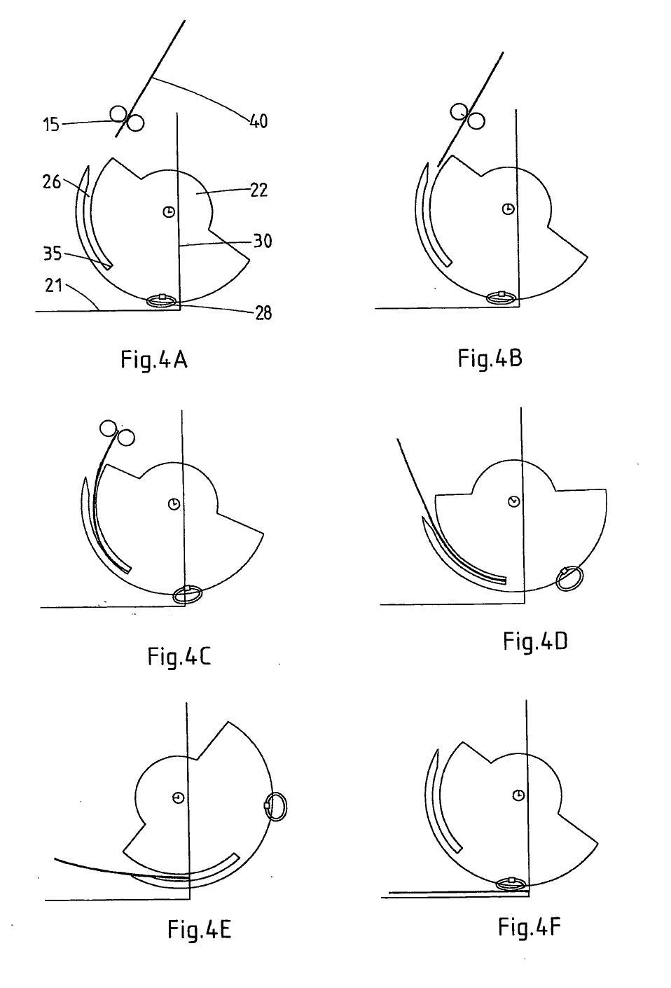

At the circumferential edge of each rotatably arranged element 22 and 23, closed-loop shaped friction elements 28 and 29 have been mounted. By actuating motor 25, rotation shaft 24 is driven in the direction of arrow B, where rotatably arranged elements 22 and 23, and as a result, also slots 26 and 27, as well as the sheet accepted within, are conveyed in the direction of stop 30 according to arrow B. During the movement of rotation shaft 24, closed-loop shaped friction elements 28 and 29 connected to it will exercise a force with a component in the direction of the stop on the upper side of the sheet that was last deposited onto receiving plane 21, so that it is conveyed against stop 30. In the description below of FIGS. 4A-4F, the movement cycle of the device will be described in more detail. It will be understood by those skilled in the art that, when receiving plane 21 does not contain any sheets, the closed-loop shaped friction elements 28 and 29 will brush over receiving plane 21.

The embodiment shown in FIG. 2 furthermore comprises a tool to restrict the freedom of movement of the edge of any sheets that have already been deposited onto receiving plane 21. This will reduce any curling or other form deformation of the sheet edge, which will have a beneficial effect on the registration behavior of sheets conveyed onto receiving plane 21. In this example, retention hooks 31 and 32 are rotatably attached at one end to the frame end and are bent at the other and in such a way that any incoming sheets conveyed from slots 26 and 27 at the level of stop 30 onto the receiving plane may easily be conveyed under the bent end of the retention hooks the while the freedom of movement of the sheet edge is restricted. The retention force of the hooks onto the sheet edge is predominantly directed downwards and may, for example, be delivered exclusively by the hooks' own weight in a gravity field and/or by means of a torsion spring at the position of attachment to the frame or by means of a magnetic pull.

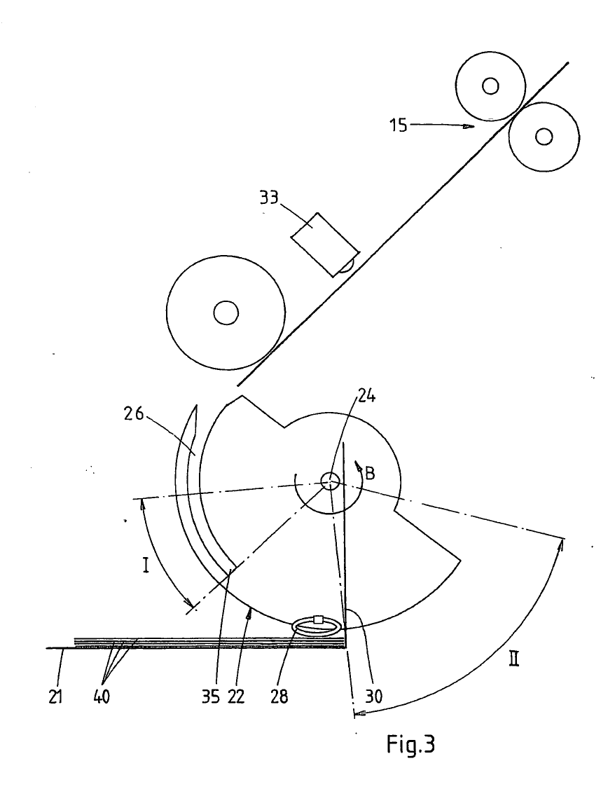

FIG. 3 is a diagram showing a side view of a device according to the present invention, in a feeding and receiving position. Depending on the angle at which the input clamping arrangement 15 is situated relative to the geometry of the rotatably arranged element 22 and, particularly, relative to slot 26, and the depth of slot 26, seen from the beginning 35 of the slot, a sheet 40 may be accepted in a first rotation zone of a shaft rotation. This first rotation zone covers the area in which a sheet 40 is accepted from input clamping arrangement 15 into slot 26. If the rotatably arranged element is driven in such a way that it is stationary, and the moment of a sheet 40 is accepted into slot 26, this first rotation zone may be very small; if rotatably arranged element 22 moves while a sheet 40 is accepted into slot 26, the size of this rotation zone will be dependent on factors such as the geometry, the rotation speed of rotatably arranged element 22 and the input speed of sheet 40 the from input clamping arrangement 15. If a sheet 40 is entirely or partially accepted into slot 26, the leading edge of sheet 40 will be conveyed against stop 30 during a rotation of the rotatably arranged element 22. This stop 30 will stop the movement of a sheet 40 present in slot 26 while rotatably arranged element 22 continues to move in rotation direction B. The rotation zone that starts the moment when sheet 40, present in slot 26, moves against stop 30 and continues up to the moment when sheet 40 has reached receiving plane 21, at that point fully detached from slot 26, is called the second rotation zone. In this second rotation zone, sheet 40, present in slot 26, is conveyed onto receiving plane 21. The exact starting point and duration of this second rotation zone will of course depend on the depth of slot 26, the length of sheet 40 in the rotation direction and the rotation speed of the rotatably arranged element 22.

FIG. 3 shows that closed-loop shaped friction element 28 is positioned in such a way that, with its circumferential edge, it can move a sheet deposited onto receiving plane 21 in the direction of stop 30 without obstructing the insertion movement of sheet 40 into slot 26 from the input clamping arrangement 15. Closed-loop shaped friction element 28 is embodied here as a strip, for example made of rubber. The material of the closed-loop shaped friction element has, in a manner generally known, been chosen such that it may develop a friction force by movement over the upper side of a sheet conveyed onto a stack, thus preventing lines or other smudges appearing on the sheet. By choosing the flexibility of the closed-loop shaped friction element correctly, a sheet will be conveyed against the stop with the right force. If the force is excessive, a sheet will deform, e.g., crumple, against the stop, and if the force is insufficient, the sheet will simply not be conveyed entirely against the stop. It will be understood by those skilled in the art that this closed-loop shaped friction element may either be an endless friction element, where the friction element forms a closed loop as such, or, for example, a strip of material attached by its two ends to a carrier that may or may not be common.

The device may also comprise a sensor 33 for detecting a sheet 40 or sheet edge. This sensor may, for example, be embodied as an optical sensor, where the passing of a sheet 40 or sheet edge is detected and where this signal may, for example, be used for driving drive motor 25.

FIGS. 4A to 4F show the operation of the device according to the present invention. In FIG. 4a, the device is in its receiving position, in the first rotation zone. Slot 26 is positioned relative to input clamping arrangement 15 in such a way that a sheet 40 may be accepted into slot 26. This first rotation zone may be very small if the rotatably arranged element is halted whilst a sheet 40 is accepted into slot 26. If the rotatably arranged element is not halted, the relative speed of accepting sheet 40 relative to the rotation speed of the rotatably arranged element will need to be high enough to at least partially accept sheet 40. FIG. 4b shows how a sheet 40 is conveyed through input clamping arrangement 15 in slot 26. When the sheet 40 is accepted into slot 26, as shown in FIG. 4C, the rotatably arranged element may be conveyed further so that the leading edge of sheet 40 will be conveyed against stop 30 during this revolution. This situation is shown in FIG. 4D. This situation shows the start of the second rotation zone. As rotatably arranged element 22 continues to rotate from this position, while the movement of sheet 40 is halted by stop 30, sheet 40 will be conveyed onto receiving plane 21. FIG. 4E shows the end of the second rotation zone. Here, sheet 40 has been entirely deposited onto receiving plane 21. Rotatably arranged element 22 may continue to rotate to the first rotation zone in which a new sheet may be accepted into slot 26 and the cycle can start all over again. Sheet 40 that is deposited onto receiving plane 21, does not yet have the right registration relative to stop 30 in this case. Thus sheet 40 may, for example, be left at some distance from stop 30. As a closed-loop shaped friction element 28 has been mounted at the circumferential edge of rotatable element 22, a force with component F in the direction of stop 30 may be exercised on the upper side of a sheet 40 which has been deposited onto receiving plane 21, so that it may still adopt the right registration relative to stop 30. This is shown in FIG. 4F. Closed-loop shaped friction element 28 must not obstruct the movement of sheet 40 from input clamping arrangement 15. In a preferential embodiment according to the present invention, the closed-loop shaped friction element is positioned along the circumferential edge of the rotatably arranged element 22, at more than one-half of a circle arc removed from the beginning 35 of slot 26 seen in the direction of movement of rotatably arranged element 22. It will be understood by those skilled in the art that the zone in which the closed-loop shaped friction element 28 may be positioned will not extend beyond a full circle arc's distance from the beginning 35 of slot 26. If the movement of sheet 40 from the input clamping arrangement 15 into slot 26 is obstructed, the registration of a formed stack will be adversely affected.

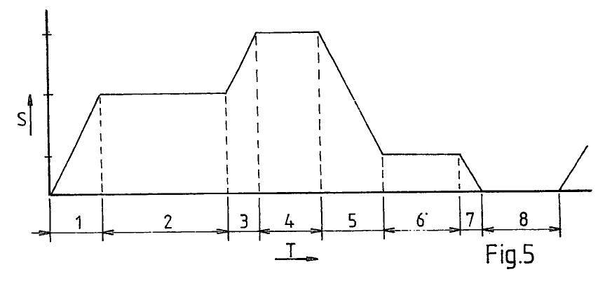

FIG. 5 shows an example showing a possible rotation speed profile. The rotation of the rotatably arranged element does not necessarily need to be constant. In this example, the rotatably arranged element is halted in the first rotation zone while a sheet is accepted into the slot. In the profile, this is phase 8. After a sheet has been accepted into the slot, the speed is increased to the first level at which the rotatably arranged element and, as a result, also the sheet accepted into the slot, will be conveyed towards the second rotation zone. This acceleration phase has been shown in FIG. 5 as phase 1. At the first speed, the sheet will come into contact with the stop during phase 2. This speed has been chosen such that the sheet edge does not suffer damage as it comes into contact with the stop. Once a sheet has been deposited onto the receiving plane, the rotatably arranged element may accelerate (phase 3) to a second, higher speed, in order to take the rotatably arranged element back to its receiving position in the first rotation zone. To prevent any extension beyond the first rotation zone, the device may be provided with a sensor to detect when the rotatably arranged element has reached the first rotation zone. This may, for example, be achieved by an optical sensor in combination with a slot in the rotatably arranged element. To detect this slot and slow down the rotatably arranged element, the decision has been made, in this speed profile, to slow down the last part of the movement towards the receiving position (phase 5) and to move it at a third, lower speed until the sensor detects the slot (phase 6) and to slow the movement down to a halt when the slot is detected (phase 7). Next, the rotatably arranged element will be stationary and the cycle may be reinstated.

In case of an error in the stacking unit the table will execute an initialization procedure during which the actual height of the table will be determined. Therefore the table will move downwards and after that upwards to level the top of the stack with the level of incoming sheets.

The motor controller can determine whether the weight of the stack on the table exceeds the capacity of the driving motor. If the weight of the stack exceeds this capacity, the stack will be ejected before continuing the initialization procedure. This ejecting is executed by moving the table down and translating the table outside of the apparatus, such that an operator can pick up the stack from the table.

The sheets in the paper path at the top of the stacking device 10 have a main transport direction from the inlet 11 towards the reversing loop 14. In case an additional apparatus is placed behind the stacking device, such as a booklet making device, or an additional stacker, an incoming sheet can be transported to the reversing loop or alternatively to the additional apparatus that is placed in series with the stacking device.

To guide the sheet in this paper path it is common practise to apply bearings on the axles that are able to rotate in one direction only, such that the transport movement of the sheets is restricted to the positive transport direction.

In general, the speed of the axle fluctuates around its nominal speed. If a sheet is transported over the axle at its higher speed the series of axles are not able to slowdown in time before the next sheet. Therefore the series of axles with one-directional bearings can easily speedup, thereby possibly damaging the sheets that are transported at the nominal speed.

If an additional apparatus is placed behind the stacking device that draws the sheets from the additional sheet exit into the additional apparatus, the sheets that are drawn out of the stacking device can accelerate the transport axles to a speed that is higher than the nominal transport speed. If these driven axles have one-directional bearings these driven axles will not immediately slowdown to the nominal transport speed after this acceleration by drawn out sheets. This can result in damages, such as wrinkling, to the sheets that are transported after the drawn out sheet, especially in the case of sheets with a relatively low longitudinal stiffness, such as is the case with many lightweight materials.

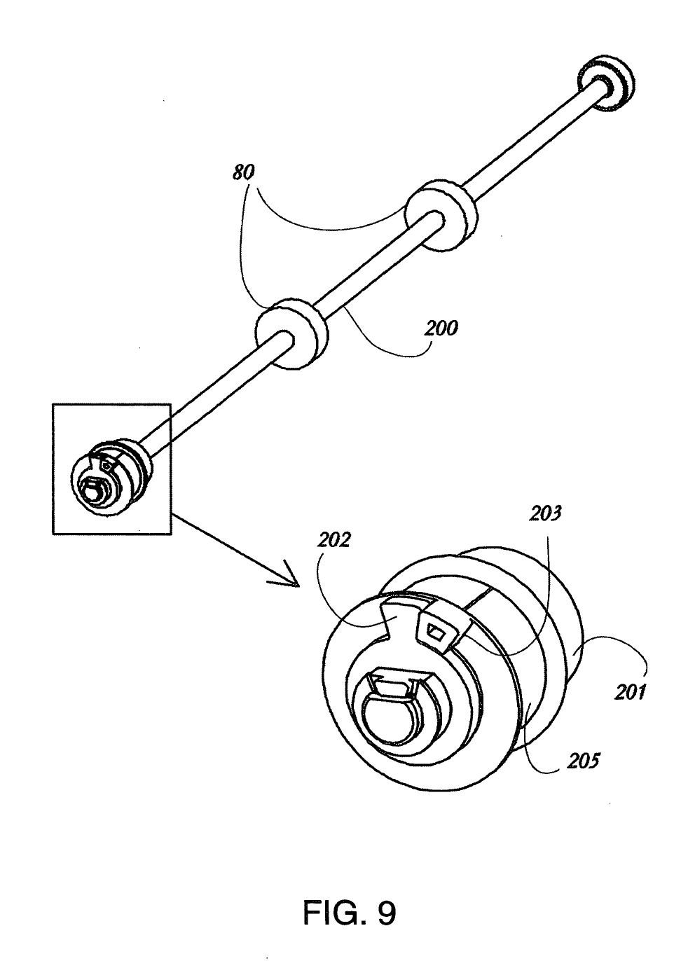

To overcome this problem the axles are implemented with bearings that have a limited degree of freedom with respect to the direction of rotation, such that the axles can more easily to slow down after a supra nominal acceleration. This degree of freedom enables the next incoming sheet to be transported reliably, as the axles can slowdown due to frictional speed losses in the play between the driven state of the bearing and the free rotational state. FIG. 9 shows an axle 200 that is supported by a bearing 201. A drive belt (not shown) that runs over a gear wheel 205 drives the axle 200. To drive the axle 200 in a positive transport direction, the gear wheel 205 runs in counter-clockwise direction. In a driven state of the axle, as shown in FIG. 9, the pusher block 203 on the gear wheel 205 pushes a stop 202 that is connected to the axle 200. If the axle is accelerated to a supra nominal speed, the stop 202 on the axle will rotate faster than the pusher block 203, thereby rotating out of contact with the pusher block 203. Therefore the bearing enables play in the direction of rotation, in this case almost a full revolution, in which the axle can slow down due to friction while not driven. The amount of play can be limited by introducing more stops 202 or more pushing blocks 203.

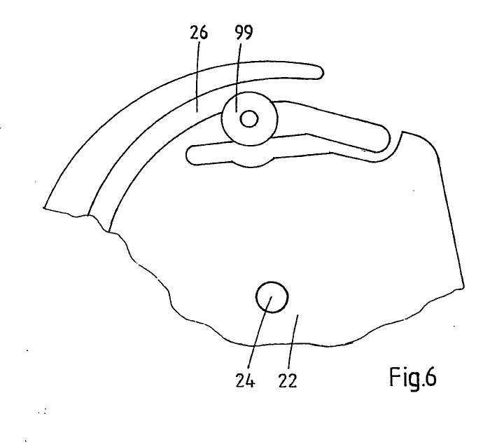

The application of these bearings enables the sheets to be transported in the transport direction in a reliable fashion, while the influence of unwanted speedups to the next sheets is limited. If the sheets which have been stacked using the device are prone to smearing, for example in the case of images printed using an inkjet printer, it is important to ensure that the sheets conveyed into the slot suffer as little friction as possible in order to reduce the chance of smearing. FIG. 6 is an example of an embodiment in which a freely rotatably arranged wheel 99 is positioned at the entrance to the slot. This wheel 99 guides the incoming sheet in the right direction and reduces the friction encountered by a sheet while being accepted into the slot. This significantly reduces the chance of smearing, without affecting the functionality of the device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A stacking device for incoming sheets, comprising:
a receiving station;
a rotatably arranged element, containing a slot at its circumferential edge for accepting at least a portion of a sheet to be stacked, where, in a first rotation zone, the rotatably arranged element accepts the sheet to be stacked and, in a second rotation zone, the accepted sheet is conveyed onto the receiving station;
drive means for driving the rotatably arranged element;
a stop operatively associated with the receiving station,
a closed-loop shaped friction element mounted at the circumferential edge of the rotatably arranged element, which, in operation, during at least part of one revolution of the rotatably arranged element, transfers a force onto the upper side of the sheet emerging from the slot, said force having a component directed towards the stop, wherein the closed-loop shaped friction element is positioned such that, in operation, it does not obstruct the movement of a sheet while the latter is accepted into the slot in the first rotation zone.

2. The device according to claim 1, wherein the friction element is mounted at a position along the circumferential edge of the rotatably arranged element, wherein this position, as seen in the conveying direction of the rotatably arranged element, is more than one-half of a circle arc removed from the beginning of the slot.

3. A device according to claim 1, wherein the drive mechanisms for driving the rotatably arranged element are driven in such a way that the moment of steering in a sheet to be stacked and the position of the rotatably arranged element are synchronised.

4. The device according to claim 1, wherein in operation, the rotational speed of the rotatably arranged element maintains a speed profile that is not constant.

5. The device according to claim 4, wherein the rotatably arranged element in operation is halted in the first rotation zone.

6. The device according to claim 1, wherein in operation the rotation speed of the rotatably arranged element is increased between the second rotation zone and the return to the first rotation zone.

7. The device according to claim 1, further comprising a sensor to indicate when the first rotation zone of the rotatably arranged element has been reached.

8. The device according to claim 1, wherein the closed-loop shaped friction element comprises a material at its circumferential edge that has a high friction ratio.

9. The device according to claim 1, wherein the rotatably arranged element comprises a freely rotatable guide wheel provided at the entry point of the slot, and positioned and dimensioned such that it extends beyond the circumferential edge of the rotatably arranged element.

10. A sheet edge retention hook, which is provided at one end with an attachment mechanism for rotatable in such a way that the hook may be attachment to a frame at least over a part of one revolution, and a the other end is shaped such that a horizontally disposed incoming sheet may be readily received under the retention hook.

11. The stacking device of claim 1, further comprising at least one sheet edge retention hook rotatably attached at one end to the frame of the stacking device, the other end of the retention hook being shaped and disposed to restrain horizontally disposed incoming sheets thereunder.
